(19) United States
(12) Patent Application Publication
(10) Pub. No.: US 2012/0115421 A1
(43) Pub. Date: May 10, 2012

(54) APPARATUS AND METHOD FOR AUTOMATIC REPLACEMENT OF WIRELESS LINK

(76) Inventors: Chwan-Chia WU, (US); Kuang-Chuan Tang, (US); Shih-Yao Hsu, (US)

(21) Appl. No.: 13/004,591

(22) Filed: Jan. 11, 2011

(30) Foreign Application Priority Data
Nov. 9, 2010 (TW) 099138449

(51) Int. Cl. H04B 15/00

(52) U.S. Cl. 455/62

(57) ABSTRACT

An apparatus and a method for automatically establishing a new wireless link when the original wireless link between the apparatus and a commercially available FM radio receiver is interfered by other signal sources and reception conditions become poor, thereby eliminating the need to manually configure both the target FM radio receiver and the apparatus to a suitable FM frequency. The apparatus receives an audio signal, modulates and transmits the audio signal to the target FM radio receiver over a selected frequency, scans an FM spectrum for an alternative frequency, transmits an Radio Data System compatible command and a forcible switching signal to configure the target FM radio receiver to tune to the alternative frequency when signal quality of the received signal deteriorate sufficiently.

This application claims the benefits of the Taiwan Patent Application Serial NO. 099138449 filed on Nov. 9, 2010, the subject matter of which is incorporated herein by reference.

### BACKGROUND OF THE INVENTION

1. Field of the Invention

The present invention relates to a method for wireless link replacement, and more particularly relates to a method for automatically establishing a new wireless link when an original wireless link is subjected to interference and not suitable for communication.

The present invention further relates to an apparatus, and more particularly relates to an apparatus, which communicates a forcible switching signal at a desired time to cause the target FM radio receiver to tune to an alternative frequency on which a desired signal is sent from the apparatus.

2. Description of the Prior Art

With the advance of digital technology, many consumer electronic devices such as MP3 players, PDAs (personal digital assistants), portable multimedia players, mobile communication devices and MIDs (mobile Internet devices), are used as portable audio devices for playing music at any time and any place.

One can use either a headphone unit or an FM radio receiver to listen to the audio (i.e., music, etc.) played by a portable audio device. When using an FM radio receiver to receive audio content played by an audio device, the audio signal provided by the audio device can be transferred to the FM radio receiver by either a wire connection or a wireless connection. When connection is via a wireless link, the audio device normally uses an FM transmitter to modulate the audio signal on an FM carrier signal and transmits this FM modulated audio signal to an FM radio receiver located relatively close by. The FM carrier is set to a particular carrier frequency that is selected from one or more available frequencies. The FM transmitter used here can be a functional unit built in the audio device, or a stand-alone unit that is connected to the audio output port of the audio device. A typical application is using an FM transmitter to convert the audio signal generated by a portable audio device to an FM signal and further transmit the FM signal over an available FM frequency. When driving a car, one can then listen to the desired audio through a car's built-in FM radio receiver as long as the FM radio receiver is tune to the frequency on which the FM signal is transmitted.

The same method can be applied to reception of audio programs broadcasted by a digital audio broadcast system. There are several digital audio broadcast systems available nowadays, which include terrestrial digital broadcasting systems such as DAB (Digital Audio Broadcasting), DRM (Digital Radio Mondiale), DMB (Digital Multimedia Broadcast), IBOC (In-Band On-Channel) system, etc., and satellite-based digital radio systems such as XM Satellite Radio, Sirius Satellite Radio, WorldSpace Europe, etc. In order to be able to receive audio programs broadcasted by digital audio broadcasters in car, one need to replace the existing analog in-car FM stereo system by a new audio system that is capable of receiving digital audio broadcast programs. Doubtlessly, this is wasteful and costly if the existing in-car audio system is a sophisticated and high quality system. Alternatively, one can install a less expensive digital radio receiver of which the main function is to receive audio programs from digital audio broadcasters. One can then apply an FM transmitter to convert the audio signal generated by the digital radio receiver to an FM modulated audio signal and then transmit this FM signal to an in-car FM radio receiver on an available FM frequency. By doing so, one can receive and listen to a desired digital audio broadcast station through the car's built-in sound system by tuning the in-car FM radio receiver to the frequency on which the desired modulated audio signal is transmitted.

As described above, if one wants to use an FM transmitter to transmit an audio signal to a nearby FM radio receiver, one needs to select an available frequency as the carrier frequency for transmission. In general, this requires back and forth operations to find an available frequency that is suitable for transmission. For example, one needs to manually search for an available frequency through a target FM radio receiver, once an available frequency is found, tune the FM transmitter manually to this selected available frequency and then broadcast the desired audio signal via this available frequency.

However, the aforementioned operation becomes unpractical when driving a car across a metropolitan area where FM spectrum is crowded, or driving on a long distance journey. This is because that a frequency available in one area may no long be available in another area. In this case, the available frequency selected by the FM transmitter for transmission has to be changed to avoid interference by other FM stations. Thereby a car driver may need to perform the above-mentioned operations again and again whenever the received signal is corrupted. Obviously, this is very inconvenient and may jeopardize safety when driving a car.

In view of this, many proposals have been developed for solving such problems. For example, U.S. Pat. No. 6,493,546 discloses an automatic scanning method for finding available channels and in the mean time monitoring the signal quality of the current transmission channel, and then providing as an advice for the user to tune to a new available channel selected for transmission.

The R.O.C. patent number I261420 discloses a method for applying to a DAB adapter, which uses the FM receiving means of the DAB adapter to automatically search for alternative frequencies over a specific spectrum. The user can then base on the search result to select one of the alternative frequencies for transmission.

Although the preceding patents propose methods for automatically scanning available channels for transmission, it is still required to manually tune the target FM radio receiver to an available channel in order to establish a wireless link between the FM transmitter and the target FM radio receiver.

US patent application number US2009/0111389A1 discloses a system and a method for automatically scanning the FM spectrum to find alternative frequencies, determining when to select one of the alternative frequencies for transmission, and communicating a signal to the other device to cause that device change to the selected available frequency. The proposed system includes an FM transmitter and an FM receiver, wherein the FM receiver is used to scan FM spectrum for finding alternative frequencies. The FM transmitter and the FM receiver are enabled interchangeably, namely; the FM transmitter and the FM receiver cannot be enabled at the same time. The FM receiver is enabled to perform frequency scanning during the periods of silence of the audio input signal. Although the aforementioned document proposes a system and a method for providing a mechanism that does not require user intervention to achieve uninterrupted listening to the audio content provided by a portable audio device through car speakers, in some circumstances, it may not be able to switch to a quiet channel successfully. This is because when driving a car across a metropolitan area where the FM spectrum is crowded, it may require changing transmission frequency frequently to avoid signal corruption by interference, and further it may take longer time to find an available frequency. As a result, a required frequency change may not take place at the desired time due to insufficient time for finding an available frequency. In this case, listeners in the car may suffer interference or even worse loss of the audio program to which is currently listening.

On the other hand, as different manufacturers of car radios may adopt different methods to determine when to switch to the selected available frequency, the technique disclosed in the above document has compatibility issue. In other words, some of the car radios may not be able to switch to the selected available frequency as desired. As such, when change of transmitting frequency is taken place, it may be still required to manually tune the car's radio to the new frequency for listening to the desired audio program continuously.

It is therefore desirable to have a mechanism, whereby a wireless link between an FM transmitter and a car's radio or target FM radio receiver is replaced automatically without the need for the user to search for an available frequency and manually tune the target FM radio receiver to the selected available frequency. It is further desirable that the transition of the wireless link from one frequency to the other is smooth and instant to avoid hearing signal interference from the car's speaker(s).

### SUMMARY OF THE INVENTION

To overcome limitations in the prior art described above, and to overcome other limitations that will become apparent upon reading and understanding the description herein of the present invention, the present invention discloses an apparatus and method for automatically establishing a new wireless link between the apparatus and a target FM radio receiver when the original link is interfered by other signal sources.

The object of the present invention is to provide a novel apparatus for and method of automatically establishing a new wireless link between an audio signal source and a target FM radio receiver. Use of the invention eliminates the need to manually configure both the FM transmitter and the target FM radio receiver to a quiet (or an available) FM channel. The invention continuously monitors an existing wireless link between the FM transmitter and the target FM radio receiver, and when the current wireless link is interfered by other signal sources, establishes a new clear wireless link automatically without manual intervention by the user. The invention achieves low latency for link setup and provides instant switchover to a new wireless link. As the invention can provide uninterrupted listening to the desired audio content without user intervention, it is therefore especially applicable to listening to audio content provided by an external audio device through car's sound system.

To ensure clear and high quality play back of the desired audio signal provided by an external audio device through the target FM radio receiver, the wireless link has to be established over a quiet channel that is not used by any signal source such as an FM station. The object of this invention is to provide a mechanism to scan the FM spectrum automatically and find one or more available frequencies that are suitable for use for transmission (i.e., for establishing a wireless link). Further, the present invention provides a mechanism to continuously monitor the current channel in use for wireless link and provides a method to determine when to establish a new link. When establishment of a new wireless link is required, the mechanism signals the target FM radio with a command that causes the target FM radio receiver to tune to the frequency selected for the new link.

A method and an apparatus for automatically establishing a new wireless link is provided according to an embodiment of the present invention. The apparatus includes a first FM transmitter, a second FM transmitter and an FM receiver. The first FM transmitter sends an FM signal over an initial frequency to the target FM radio receiver so as to establish a wireless link between the apparatus and the target FM radio receiver. The method includes the following steps: the FM receiver scanning an FM spectrum for at least an available frequency to be selected as an alternative frequency; the first FM transmitter transmitting an alternative frequency signal over the initial frequency to the target FM radio receiver, wherein the alternative frequency signal includes information of the alternative frequency; the second FM transmitter transmitting the FM signal over the alternative frequency; the apparatus examining signal quality of the initial frequency to determine whether the initial frequency is subjected to interference and thereby not suitable for communication; when the initial frequency is determined not suitable for communication, the first FM transmitter transmitting a forcible switching signal over the initial frequency so as to force the target FM radio receiver to tune to the alternative frequency, and to establish a new wireless link with the apparatus to receive the FM signal transmitted from the second FM transmitter.

According to an embodiment of the present invention, the step of scanning an FM spectrum further includes configuring the FM receiver to go through each of a plurality of frequencies to be examined in the FM spectrum so as to measure the signal strength of each frequency to be examined. The frequencies to be examined may vary from country to country and may make reference to the bandplan of the country where the present invention is applied. In general, every country has a bandplan for a particular radio band. The bandplan defines the frequency range to be included, how channels are to be defined, etc. Based on such bandplan, channel separation requirements are applied for channel allocation to avoid cross interference between two adjacent channels. For example, in the United States the FM channels are allocated from 87.9 MHz to 107.9 MHz, and the center frequencies of two adjacent channels are separated by 200 kHz. Therefore, it is preferably programmed to scan every 200 kHz when applying the present invention in the United States. Likewise, it may be programmed in accordance with different channel spacing allocations and FM broadcast band in other countries, and, for example, to scan every 100 kHz of the FM broadcast band in Europe.

According to an embodiment of the present invention, the step of the apparatus examining signal quality of the initial frequency to determine whether the initial frequency is not suitable for communication further includes when the signal quality goes below a predetermined threshold of signal quality, the initial frequency is considered subjected to interference and not suitable for communication.

According to an embodiment of the present invention, the FM signal includes a Program Identification (PI) code and the forcible switching signal includes a PI code different from that of the FM signal.

According to an embodiment of the present invention, the transmission power of the forcible switching signal is less than the transmission power of the FM signal transmitted over the initial frequency by the first FM transmitter.

An apparatus is further provided according to an embodiment of the present invention for receiving an audio signal, modulating the audio signal to an FM signal, sending the FM signal to a target FM radio receiver over an initial frequency. The apparatus includes an FM receiver, a processor, a first FM transmitter and a second FM transmitter. The FM receiver is for receiving a plurality of signals and examining reception conditions of the received signals to generate an environmental information signal, where reception conditions may be obtained by measuring the signal strength and/or signal quality (such as received signal strength indication (RSSI), signal-to-noise ratio (SNR), bit error rate, etc.) of the received signals, The processor, electrically connected to the FM receiver, is for receiving the environmental information signal, accordingly searching for at least an available frequency as an alternative frequency, and determining whether the initial frequency is subjected to interference and not suitable for communication. The first FM transmitter, electrically connected to the processor, is for receiving the audio signal, and sending a first FM signal over the initial frequency to the target FM radio receiver by modulating the audio signal incorporating an RDS (Radio Data System) information, where the RDS information includes information of the alternative frequency and a PI code. The second FM transmitter, electrically connected to the processor, is for receiving the audio signal, and sending a second FM signal over the alternative frequency by modulating the audio signal incorporating the PI code similar to that of the first FM signal; wherein when the processor determines that the initial frequency is not suitable for communication, the processor generates a forcible switching signal for the first FM transmitter to send over the initial frequency so as to cause the target FM radio receiver to tune to the alternative frequency for receiving the second FM signal sent from the second FM transmitter.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a system block diagram illustrating a wireless link established between an FM radio receiver and an embodiment of an apparatus according to the present invention;

FIG. 2 is an embodiment of an apparatus of the present invention;

FIG. 3 is an another embodiment of the apparatus of the present invention;

FIG. 4 is yet another embodiment of the apparatus of the present invention; and

FIG. 5 is a flow diagram illustrating an automatic wireless link replacement method of the apparatus of the present invention.

### DETAILED DESCRIPTION OF THE PREFERRED EMBODIMENTS

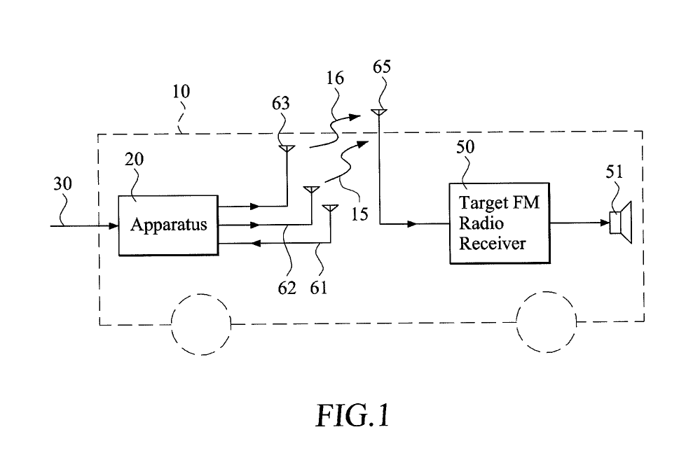

FIG. 1 shows a system block diagram illustrating an example wireless link established between an FM radio receiver and an apparatus; both are installed in a vehicle. The system 10 includes an apparatus 20, a target FM radio receiver 50 and speaker(s) 51.

In one general aspect, an audio input signal 30 provided by an external audio device (not shown in the drawing) is sent to the apparatus 20, where the audio input signal 30 is frequency modulated to a first signal 15. The first signal 15 is further transmitted over a selected frequency (denoted as initial frequency throughout this document) through a first antenna 62. The first signal 15 is received by the target FM radio receiver 50 via an antenna 65. The target FM radio receiver 50 demodulates the received first signal 15 and sends the resulting demodulated audio signal to the car speaker(s) 51 from which the audio input signal 30 is reproduced.

The first signal 15 is thereby considered as a wireless link between the apparatus 20 and the target FM radio receiver 50 as long as the target FM radio receiver 50 is tuned to the selected frequency transmitted by the apparatus 20.

The apparatus 20 also modulates the audio input signal 30 to a second signal 16 and transmits this second signal 16 over another selected frequency (denoted as alternative frequency throughout this document) through a second antenna 63. This second signal 16 is to be used as an alternative signal when reception conditions of the first signal 15 by the target FM radio receiver 50 deteriorate sufficiently.

In one exemplary embodiment of the invention, the target FM radio receiver 50 is compatible with the Radio Data System (RDS) (or the Radio Broadcast Data System (RBDS), the official name used for the United States version of RDS), meaning that the target FM radio receiver 50 is configured to receive and understand the received RDS bitstream. The apparatus 20 may further include a third antenna 61 to receive a plurality of signals for scanning an FM spectrum for finding available frequencies, and for monitoring the signal quality of the wireless link 15 and the second signal 16.

The audio input signal 30 is provided by an external audio device. Examples of external audio devices include personal digital assistants (PDAs), mobile communication devices, digital audio radio receivers, portable music players, and the like, wherein mobile communication devices include cellular phones, mobile Internet devices (MIDs), and so forth; digital audio radio receivers include terrestrial digital broadcast radio receivers, satellite digital radio receivers; and portable music players include CD players, MP3 players, iPod®, portable multimedia players, and so forth.

To ensure clear reception by the target FM radio receiver 50 of the audio signal sent from the apparatus 20, the frequency selected for transmission and used for establishing the wireless link 15 needs to be an available frequency that is not used by any FM station for broadcast. However, a particular frequency available for transmission in one geographic area may become unavailable in another geographic area, where there is an FM station broadcasting either on this particular frequency or on a nearby frequency. Therefore, the frequency used for transmission of a signal from the apparatus 20 to the target FM radio receiver 50 needs to be changed, when the system 10 is moving toward a geographic area, where the current transmission is interfered by other signal sources.

The present invention thereby provides a mechanism to establish a new and clear wireless link between the apparatus 20 and the target FM radio receiver 50 when the present wireless link is subjected to interference and not suitable for communication. In one exemplary embodiment of the present invention, the mechanism is operable to continuously monitor the spectrum status of the FM spectrum by the apparatus 20. The apparatus 20 scans the FM spectrum continuously or periodically for finding available frequencies, selects one of the available frequencies as an alternative frequency, examines the signal quality of the present wireless link, and when the signal quality is determined poor sends a forcible switching signal from the apparatus 20 to cause the target FM radio receiver 50 to tune to the alternative frequency for receiving the desired audio signal continuously.

The mechanism makes use of the feature of alternative frequency (AF) defined in the RDS standard. The mechanism generates and sends an RDS information over the initial frequency to the target FM radio receiver 50, where the RDS information includes at least a Program Identification code—hereafter called PI code and a jump command in which a coded AF data is included to specify the selected alternative frequency. One application of this PI code would be to enable the receiver to search automatically for an alternative frequency included in the AF data of the jump command in case of poor reception of the program to which the receiver is tuned; the switchover to the new frequency would take place if a clear signal present on that frequency having the same PI code. Therefore, this jump command instructs the target FM radio receiver 50 to jump to the alternative frequency when reception conditions deteriorate sufficiently so that the target FM radio receiver 50 can continuously receive the modulated audio signal sent by the apparatus 20.

The mechanism provided by the present invention further includes sending a first signal 15 and a second signal 16 from the apparatus 20. The first signal 15 is transmitted over the initial frequency via a first antenna 62 to the target FM radio receiver 50, and includes a frequency modulated audio signal and an RDS information having a PI code, wherein the RDS information may further include an alternative frequency signal, i.e., an AF data specifying the selected alternative frequency.

The second signal 16 is transmitted over the selected alternative frequency via a second antenna 63, and includes a frequency modulated audio signal and an RDS information having a PI code.

When reception of the first signal 15 becomes poor, the target FM radio receiver 50 would automatically tune to the selected alternative frequency specified in the RDS AF data of the first signal 15 and receive the second signal 16, which, as stated above, is an alternative signal of the first signal 15.

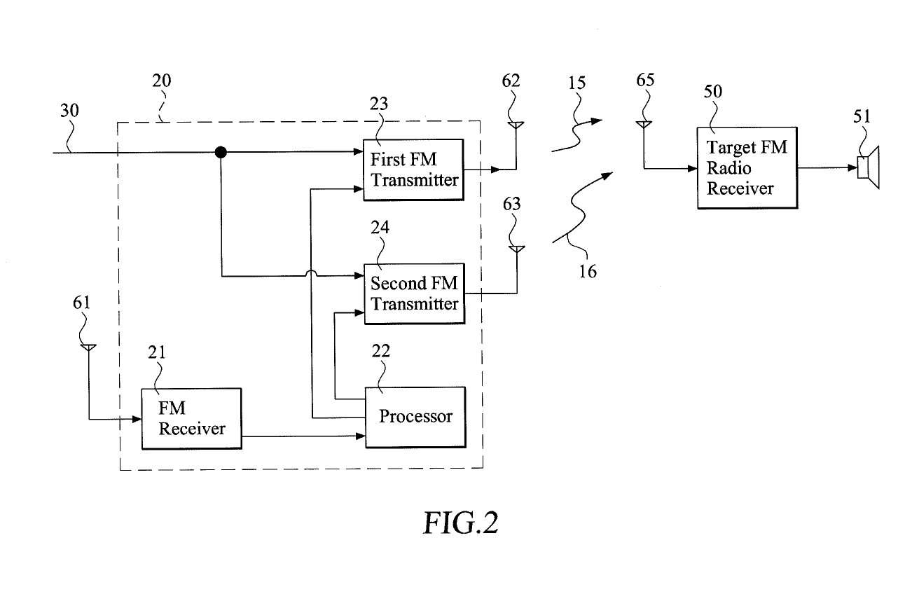

In accordance with one exemplary embodiment of the present invention, the apparatus 20, as illustrated in FIG. 2, includes a processor 22, a first FM transmitter 23, a second FM transmitter 24, an FM receiver 21, a first antenna 62, a second antenna 63, and a third antenna 61.

The FM receiver 21 is operable to receive a plurality of signals (not shown), examine reception conditions of these signals, and accordingly to generate an environmental information signal (not shown). According to an embodiment of the present invention, the FM receiver 21 is connected to a third antenna 61 and is configured in such a manner to be operable to scan the FM spectrum for finding available frequencies. The FM receiver 21 may go through each potential frequency and determine whether a signal is present on that particular frequency by measuring the signal strength (for example, received signal strength indication (RSSI)). If the signal strength, such as RSSI, of a particular frequency exceeds a predetermined threshold value, it may be considered that a signal is present on that particular frequency. A particular frequency may be considered available if the signal strength (RSSI) is equal to or less than the predetermined threshold value.

The FM receiver 21 is also operable to determine the signal quality of a signal over a particular frequency. The signal quality of a desired signal may degrade if there is one or more other signal sources present on the same or close to the particular frequency on which the desired signal is present. The signal quality of a particular frequency may be analyzed by measuring a signal strength (RSSI) or a signal-to-noise ratio (SNR) of the received signal. For example, the desired signal may be considered poor and/or interfered by other sources if the SNR reading is below a predetermined threshold value.

The processor 22 is electrically connected to the FM receiver 21 for receiving the environmental information signal, accordingly searches for at least an available frequency as an alternative frequency, and determines whether the initial frequency is suitable for communication.

The first FM transmitter 23 is electrically connected to the processor 22 and is configured to be operable to receive an audio input signal 30 and generate a first signal 15 by modulating this audio signal 30 and a first RDS information, the resulting first signal 15 is transmitted over the initial frequency via the first antenna 62. The first RDS information includes a PI code and information of alternative frequency.

The second FM transmitter 24 is electrically connected to the processor 22 and is configured to be operable to receive an audio input signal 30 and generate a second signal 16 by modulating this audio signal 30 and a second RDS information, the resulting second signal 16 is transmitted over the alternative frequency via the second antenna 63. The second RDS information includes a PI code, which is identical to that of the first signal 15 transmitted by the first FM transmitter 23; wherein the signals transmitted by the first FM transmitter 23 and the second FM transmitter 24 are compatible with the RDS.

When the processor 22 determines that the initial frequency is not suitable for communication, the processor 22 generates a forcible switching signal (not shown) for the first FM transmitter 23 to send over the, initial frequency via the first antenna 62 so as to force the target FM radio receiver 50 to tune to the alternative frequency for receiving the second signal 16 sent from the second FM transmitter 24; wherein the forcible switching signal may include a PI code other than that of the first signal 15 to force the target FM radio receiver 50 to tune to the alternative frequency after receiving the forcible switching signal, and/or the forcible switching signal may be generated by reducing the transmission power of the first signal 15 so that the signal quality received by the target FM radio receiver 50 over the initial frequency is further deteriorated, as such causing the target FM radio receiver 50 to tune to the alternative frequency for better reception.

According to an embodiment of the present invention, after the forcible switching signal is sent, the processor 22 may control the first FM transmitter 23 to send the first signal 15 over the alternative frequency and disable the second FM transmitter 24, and thereafter the target FM radio receiver 50 receives the first signal 15 over the alternative frequency.

In accordance with one exemplary embodiment of the invention, the apparatus 20 may be arranged and configured to operate as a standalone device as shown in FIG. 2. The apparatus 20 may be connected to an audio output device (not shown in the diagram) from which an audio signal 30 is provided and sent to the apparatus 20.

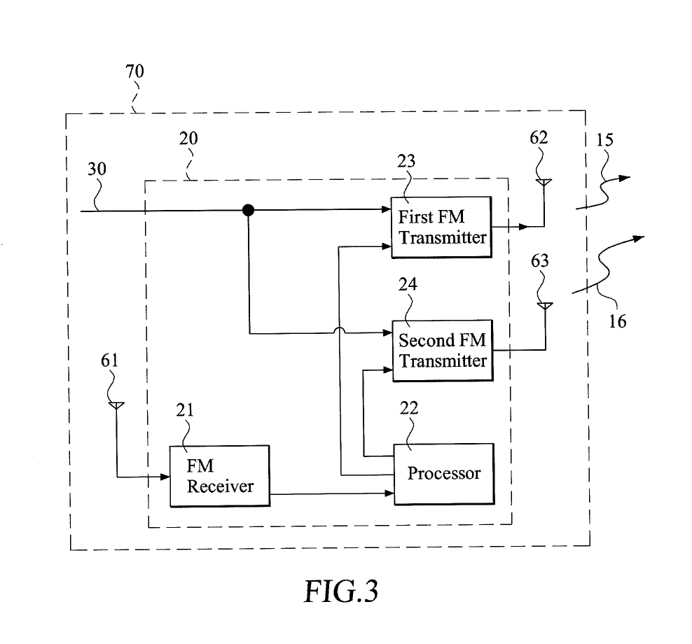

In other exemplary embodiment of the invention, the apparatus 20 may be integrated into or otherwise be made a part of a portable device 70 as shown in FIG. 3. As an example, the portable device 70 may include a multimedia player (such as MP3 player, iPod®, CD player or any other audio and/or video player), a personal digital assistant (PDA), a mobile communication device (such as cellular phone, mobile Internet device (MID)), and/or a device that includes any combination of these types of devices.

Referring again to FIG. 1, the audio signal 30 may be originated from a satellite broadcasting signal or a terrestrial digital broadcasting signal, it is therefore desirable to have a digital radio receiving device that includes an apparatus 20 and a terrestrial digital audio/video broadcast receiver and/or a satellite digital radio receiver for receiving digital broadcasting signal, converting the received audio signal to an FM signal and further sending the resulting FM signal to the target FM radio receiver 50 and finally reproducing the audio signal via the speaker(s) 51.

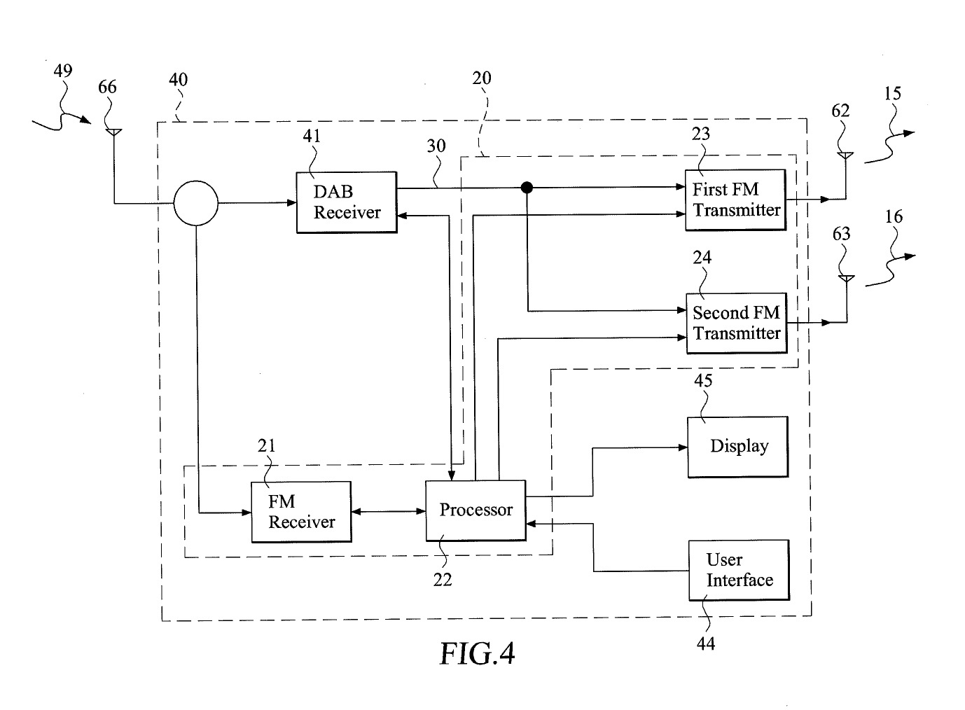

To this end, another exemplary embodiment of the present invention will now be described in detail with reference to FIG. 4. As shown in FIG. 4, a digital radio receiving device 40 includes a digital audio broadcasting (DAB) receiver 41, a user interface 44, a display 45, an apparatus 20 and an antenna 66. The apparatus 20 further includes a processor 22, a first FM transmitter 23, a second FM transmitter 24, an FM receiver 21, a first antenna 62 and a second antenna 63.

The DAB receiver 41 is connected to the processor 22 and the antenna 66, and is operable to receive and convert a selected DAB signal 49 to an audio signal 30. The user interface 44 is connected to the processor 22 for selecting a desired DAB station and performs other system settings and/or controls to the digital radio receiving device 40. The resulting control signal 46 is sent to the processor 22 for performing corresponding operations in response to the user's requests. The display 45 is connected to the processor 22 for displaying messages provided by the processor 22.

In one exemplary embodiment of the invention, the antenna 66 is also connected to the FM receiver 21 for receiving a plurality of FM signals. The antenna 66 is thereby a multi-band antenna that is at least applicable to FM band (87.5 MHz-108 MHz) and Band III (174 MHz-240 MHz) reception.

The processor 22 is configured to control the DAB receiver 41 based on the control signals 46 sending out from the user interface 44. The DAB receiver 41 performs the specific operations requested by the processor 22 and responds messages that may include DAB station name and other related information, such as radiotext Dynamic Label Segment (DLS), etc., to the processor 22. The processor 22 further shows the messages on the display 45.

The digital radio receiving device 40 may include a DAB receiver 41 as shown in FIG. 4. The digital radio receiving device 40 may also include a receiver of other types of digital broadcasting systems for receiving audio signals of that particular digital broadcasting system. Examples of the digital broadcasting systems include terrestrial digital broadcasting systems such as Digital Radio Mondiale (DRM), Digital Multimedia Broadcast (DMB), In-Band On-Channel (IBOC) systems, etc., and satellite-based digital radio systems such as XM Satellite Radio, Sirius Satellite Radio, WorldSpace Europe, etc.

As shown in FIGS. 2, 3 and 4, the apparatus 20 searches for available frequencies, selects an alternative frequency from the available frequencies, transmits the first signal 15 over the initial frequency and the second signal 16 over the selected alternative frequency so as to direct the target FM radio receiver 50 to receive the second signal 16 over the alternative frequency when reception of the first signal 15 becomes poor. As a result a new wireless link is established automatically and reception of the desired audio signal via the target FM radio receiver 50 would not be interrupted when establishment of such new wireless link is in progress

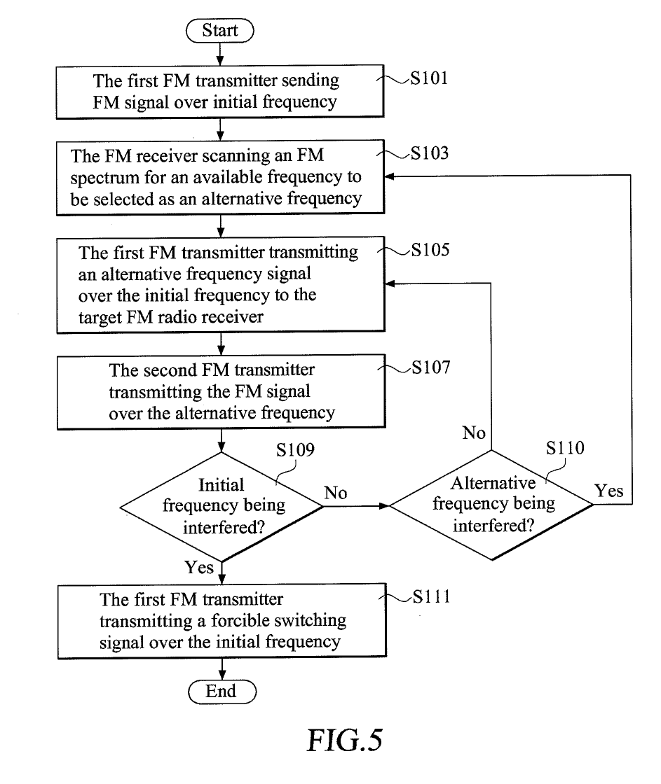

Referring to FIG. 5 together, a flow diagram is shown to depict an automatic wireless link replacement method of the present invention. This method is may be implemented in the apparatus 20 of FIGS. 2, 3 and 4, as described above. It may be implemented in software/firmware for execution by a suitable processor, in hardware for execution by appropriate circuitry or a combination of both software /firmware and hardware.

Initially, when the first FM transmitter 23 sends a first signal 15 over the initial frequency to the target FM radio receiver 50, wherein the first signal 15 includes a modulated audio signal and an RDS information that at least includes a PI code, where the PI code is assigned to represent the apparatus 20 (step S101); next, the FM receiver 21 scans the FM spectrum for one or more available frequencies and selects one of the available frequencies as the alternative frequency (step S103). The available frequencies should be sufficiently quiet to permit the reception of the FM transmitter signal. A frequency may be considered available if the reading of the signal strength (such as received signal strength indication (RSSI)) of this frequency is equal to or below a predetermined threshold value. In the process of scanning the FM spectrum, the method further includes the step of configuring the FM receiver 21 to receive signal on each frequency to be examined in the FM spectrum and measure the signal strength of that signal. As stated above, the FM receiver 21 may be programmed to step through the FM spectrum in accordance with the channel spacing allocations of a particular country where the present invention applied, for example, the FM receiver 21 may be preferably programmed to scan every 200 kHz in the United States and may be programmed to scan every 100 kHz in the countries in Europe.

An alternative frequency signal is then generated and transmitted incorporating the first signal 15 by the fist FM transmitter 23 over the initial frequency to the target FM radio receiver 50 (step S105), where the alternative frequency signal is compatible with RDS and includes an AF data in which the selected alternative frequency is specified. The target FM radio receiver 50 receives this RDS bitstream, decodes it and marks the received data as the alternative frequency for the frequency that the target FM radio receiver 50 is currently tuned to. The target FM radio receiver 50 will jump to the alternative frequency when reception conditions deteriorate sufficiently.

After the alternative frequency is selected, the second FM transmitter 24 transmits a second signal 16 on the alternative frequency (step S107). This second signal 16 includes an FM modulated audio signal and an RDS information, where the RDS information includes a PI code which is similar to that of the first signal 15.

Next, the signal on the initial frequency is examined to determine whether this frequency is suitable for communication (step S109). In one exemplary embodiment of the invention, the FM receiver 21 is configured to tune to the initial frequency, on which the first FM transmitter 23 is currently transmitting the first signal 15. The signal quality of this frequency may be analyzed by measuring the signal-to-noise ratio (SNR) of the received signal.

If the measured SNR is below a predetermined threshold value, the received signal may be interfered by other signal sources and the initial frequency is considered not suitable for communication; conversely, if the SNR reading equals to or exceeds the predetermined threshold value, the initial frequency is considered suitable for communication.

If the initial frequency is determined suitable for communication, the signal on the alternative frequency is examined to determine whether this alternative frequency is suitable for communication of a desired signal (step S110). If it is determined suitable for communication, the second signal 16 is transmitted continuously over the alternative frequency by the second FM transmitter 24, and the signal quality on the initial frequency is examined repeatedly. Conversely, if the alternative frequency is found not suitable for transmission, it is required to search for available frequencies again and select one of the available frequencies as the alternative frequency.

When the initial frequency is determined not suitable for communication, the first FM transmitter 23 is configured to generate and send a forcible switching signal that is adapted to further deteriorate the signal over the frequency which the target FM radio receiver 50 is currently tuned to (step S111). In one exemplary embodiment of the invention, this forcible switching signal may be the first signal 15 sent by the first FM transmitter 23 with a lower transmission power. In another exemplary embodiment of the invention, this forcible switching signal may be generated by changing the PI code of the first signal 15 such that the PI code included in this signal is different from the PI code representing the apparatus 20. This causes the target FM radio receiver 50 to jump to the alternative frequency over which the second FM transmitter 24 is transmitting the second signal 16, wherein the second signal 16 having the PI code similar to that of the first signal 15.

In conclusion, after the alternative frequency being selected, the apparatus 20 of the present invention transmits the first signal 15 and the second signal 16 over the initial frequency and the alternative frequency, respectively. As such, the target FM radio receiver 50 can tune to the alternative frequency to receive the second signal 16 automatically when the original wireless link 15 is subjected to interference and determined no longer suitable for communication. Even the target FM radio receiver 50 adopts more rigid criteria for performing the AF feature and may thereby jump to the alternative frequency prior to the forcible switching signal being generated and sent out by the apparatus 20, the target FM radio receiver 50 can still receive the desired audio signal 30 continuously as the second signal 16 having the PI code representing the apparatus 20 is being transmitted over the alternative frequency by the apparatus 20.

While the apparatus has been described in terms of its component circuits, it should be noted that any or all of these circuits may be implemented in software or hardware or any combination thereof, including but not limited to Application Specific Integrated Circuits (ASICs) or Field Programmable Gate Arrays (FPGAs) or any equivalent technology.

The steps of the method described above may be constructed as software objects that are executed in embedded devices as firmware, software objects are executable as part of a software application on either an embedded or non-embedded computing system such as a digital signal processor (DSP), reduced instruction set computing (RISC) processor, microcomputer, microprocessor, etc., or as soft core realized HDL circuits embodied in an Application Specific Integrated Circuits (ASICs) or Field Programmable Gate Arrays (FPGAs) or as functionally equivalent discrete hardware components.

While the present invention has been particularly shown and described with reference to preferred embodiments, it will be understood by those skilled in the art that various changes in form and detail may be without departing from the spirit and scope of the present invention.

What is claimed is:

1. A method for automatically establishing a new wireless link when an original wireless link between an apparatus and a target FM radio receiver is subjected to interference and not suitable for communication, wherein said apparatus includes a first FM transmitter, a second FM transmitter and an FM receiver, said first FM transmitter transmitting a first signal over an initial frequency, said target FM radio receiver tuning to said initial frequency so as to establish said original wireless link with said apparatus and receive said first signal, the method comprising the following steps:
(a) said FM receiver scanning an FM spectrum for one or more available frequencies and selecting one of said one or more available frequencies as an alternative frequency;
(b) said first FM transmitter communicating an alternative frequency signal over said initial frequency to said target FM radio receiver, wherein said alternative frequency signal includes information of said alternative frequency;
(c) said second FM transmitter transmitting a second signal over said alternative frequency;
(d) said apparatus examining signal quality of said initial frequency to determine whether said initial frequency is suitable for communication;
(e) said apparatus examining signal quality of said alternative frequency to determine whether said alternative frequency is suitable for communication; and
(f) when said initial frequency is determined not suitable for communication and said alternative frequency is determined suitable for communication, said first FM transmitter transmitting a forcible switching signal over said initial frequency so as to force said target FM radio receiver to tune to said alternative frequency, thereby establishing said new wireless link with said apparatus to receive said second signal transmitted from said second FM transmitter.

2. The method of claim 1, wherein said step (a) further includes configuring said FM receiver to go through each of a plurality of frequencies to be examined in the FM spectrum so as to measure the signal strength of said each of a plurality of frequencies to be examined.

3. The method of claim 1, wherein said steps of examining signal quality of a selected frequency further comprises the step of measuring a signal quality of said selected frequency and determining said selected frequency not suitable for communication when said signal quality of said selected frequency goes below a predetermined threshold of signal quality.

4. The method of claim 1, wherein said first signal includes a Program Identification (PI) code, said second signal includes a PI code identical to that of said first signal.

5. The method of claim 1, wherein said forcible switching signal includes a PI code different from that of said first signal.

6. The method of claim 1, wherein the transmission power of said forcible switching signal is less than the transmission power of said first signal transmitted over said initial frequency by said first FM transmitter.

7. The method of claim 1, wherein signals sent by said first FM transmitter and said second FM transmitter are compatible with the Radio Data System (RDS).

8. An apparatus for receiving an audio signal, modulating said audio signal, and sending said modulated audio signal to a target FM radio receiver over an initial frequency, the apparatus comprising:
an FM receiver for receiving a plurality of signals and examining reception condition of each of said a plurality of signals to generate an environmental information signal;
a processor electrically connected to said FM receiver for receiving said environmental information signal, accordingly searching for an available frequency as an alternative frequency, and determining whether said initial frequency is suitable for communication;
a first FM transmitter electrically connected to said processor for receiving said audio signal, and communicating a first signal over said initial frequency to said target FM radio receiver by modulating said audio signal incorporating an RDS information, wherein said RDS information including information of said alternative frequency and a first PI code; and
a second FM transmitter electrically connected to said processor for receiving said audio signal, and sending a second signal over said alternative frequency by modulating said audio signal incorporating said first PI code;
wherein, when said initial frequency is determined not suitable for communication, said processor generates a forcible switching signal for said first FM transmitter to send to said target FM radio receiver over said initial frequency to cause said target FM radio receiver to tune to said alternative frequency for receiving said second signal sent from said second FM transmitter.

9. The apparatus of claim 8, wherein said forcible switching signal includes a second PI code.

10. The apparatus of claim 8, wherein the transmission power of said forcible switching signal is less than the transmission power of said first signal transmitted over said initial frequency by said first FM transmitter.

11. The apparatus of claim 8, wherein signals transmitted by said first FM transmitter and said second FM transmitter are compatible with the RDS.
